(19) United States
(12) Patent Application Publication
(10) Pub. No.: US 2006/0055086 A1
(43) Pub. Date: Mar. 16, 2006

(54) Collet Gripper Golf ball extractor

(75) Inventors: Mark A. Cloutier, Wilbraham, MA (US); Vincent J. Simonds, Brimfield, MA (US); Mario Jarmuzewski, Chicopee, MA (US)

Correspondence Address: LAW OFFICE OF LAWRENCE E. LAUBSCHER, JR., 1160 SPA ROAD, SUITE 2B, ANNAPOLIS, MD, 21403, US

(73) Assignee: Callaway Golf Company, Carlsbad, CA (US)

(21) Appl. No.: 10/941,526

(22) Filed: Sep. 15, 2004

(51) Int. Cl. B29C 45/42

(52) U.S. Cl. 264/334; 425/436 RM; 425/436 R

(57) ABSTRACT

An apparatus for removing molded golf balls from a golf ball mold without the use of ejector pins includes a frame, a device for moving the frame relative to the golf ball mold, and at least one gripper mechanism on the frame. The gripping mechanism includes a plurality of radially spaced gripping fingers with longitudinal axes parallel to the central axis of the gripping mechanism. The gripping fingers are initially spaced away from the central axis while the frame is positioned to align the central axis of the gripping mechanism with a central axis of the golf ball. The gripping fingers are then displaced toward the central axis to clamp onto, and partially deform, the golf ball. The frame is subsequently moved away from the mold, and the gripping fingers are displaced away from the central axis to release the golf ball which then returns to its original configuration.

### BACKGROUND OF THE INVENTION

In the golf ball manufacturing process, it is common practice to form the cover of the golf ball using injection molding. A mold comprising a pair of parallel plates containing opposed hemispherical cavities is used to form a spherical cavity within which a fluid thermoplastic material is supplied around a golf ball core. Dimples on the finished golf ball are formed by protrusions in the mold cavities.

After the thermoplastic material sets, the plates are separated and the golf ball is removed from the cavity. The protrusions in the cavities impede the removal of the molded golf ball, and, therefore, it is common practice to provide ejector or knockout pins in the cavity of the mold plates which eject the ball out of the mold. A major drawback to the use of ejector pins is that the pins blemish the outer surface of the ball. Another drawback is that the channels within which the pins move become clogged with molten thermoplastic material.

The present invention relates to an apparatus for extracting molded golf balls from an upper or lower mold cavity without the use of ejector pins, thereby eliminating surface imperfections and simplifying the operation of the mold apparatus.

### SUMMARY OF THE INVENTION

Accordingly, it is a primary object of the present invention to provide a mechanism to remove a molded golf ball from an injection mold without the use of ejector or knockout pins. The extraction mechanism includes a frame on which is mounted at least one gripping mechanism which has a central axis. The gripping mechanism includes a plurality of radially spaced gripping fingers with their longitudinal axes parallel to the central axis of the gripping mechanism. The central axis of the gripping mechanism is aligned with a central axis of the molded golf ball. The gripping fingers are displaced laterally toward the central axis with sufficient force to partially compress at least the golf ball cover so that the ball surface clears the protrusions in the golf ball mold when the frame is moved away therefrom. The gripping fingers are subsequently displaced away from the central axis, whereby the golf ball is released so that it may return to its original configuration. The gripping fingers may be made of any material sufficient to withstand the forces necessary to compress the molded golf ball without marring the surface of the ball, and may also be contoured to match the curvature of the golf ball or the aerodynamic surface pattern of the ball.

According to a further object of the invention, the gripping fingers are designed such that the force applied to the golf ball is equally spaced about the central axis, thereby reducing the possibility of deforming the molded golf ball.

### BRIEF DESCRIPTION OF THE FIGURES

Other objects and advantages of the invention will become apparent from a study of the following specification when viewed in the light of the accompanying drawings, in which:

FIG. 1 is a sectional view of a lower plate of a golf ball injection mold according to the prior art and including a molded golf ball prior to removal from the golf ball mold;

FIG. 2 is a sectional view of the golf ball and mold of FIG. 1, showing ejector pins extended into the spherical cavity for pushing the molded golf ball out of the mold;

FIG. 3 is a plan view of the preferred embodiment of the golf ball extractor of the present invention;

FIG. 4 is a bottom view of the gripping mechanism of the golf ball extractor mechanism of the invention;

FIG. 5 is a bottom view of a gripping mechanism according to the invention;

FIG. 6 is a sectional view of a gripping mechanism taken along line 6-6 of FIG. 5;

FIG. 7 is a partial sectional plan view of a golf ball extractor according to the invention with the gripping mechanism in its gripping position.

### DETAILED DESCRIPTION

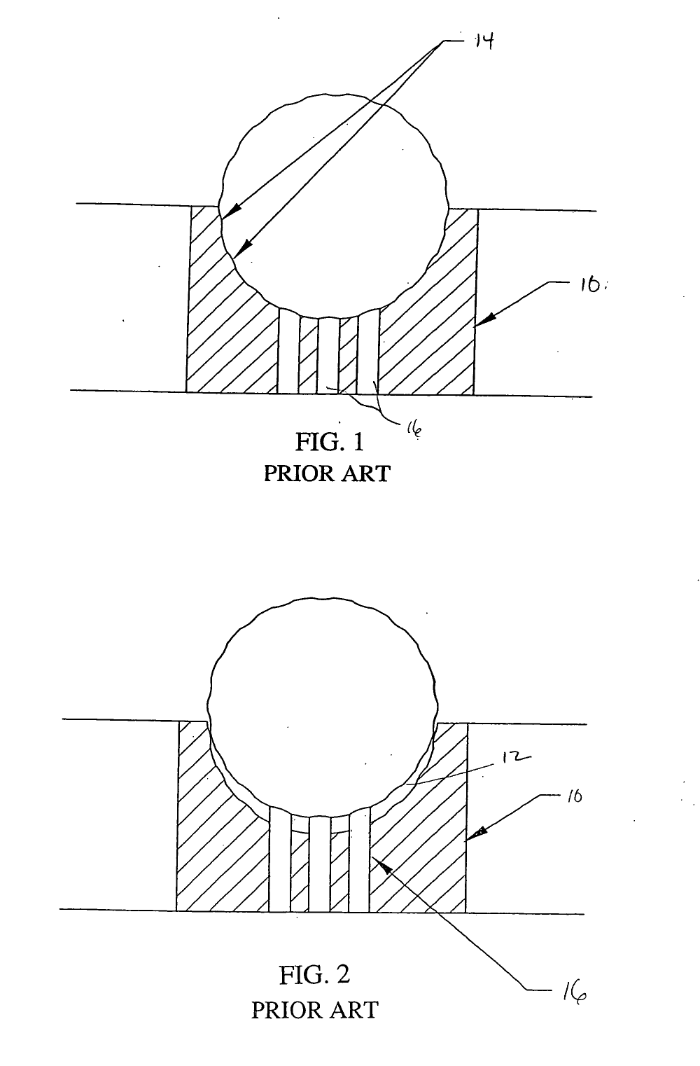

Referring initially to FIGS. 1 and 2, the method of extracting a golf ball from an injection mold according to the prior art will be described. The mold includes a lower plate 10 containing at least one hemispherical cavity 12 designed to correspond to a similar cavity in an upper plate (not shown). Protrusions 14 formed in the plates produce dimples in the molded golf ball, but also impede removal of the molded golf ball. To overcome the restriction provided by the protrusions, retractable ejector or knockout pins 16 are provided in the lower plate 10. Once the ball has cured, the ejector pins 16 are extended into the cavity to push the molded golf ball out of the cavity.

The prior art method suffers from a number of drawbacks. First, if the force applied to the golf ball by the ejector pins 16 is set too high, the molded golf ball may be damaged. Furthermore, thermoplastic material may remain in the voids between the lower plate 10 and the ejector pins 16, which clog the pins or otherwise cause imperfections in the ball surface.

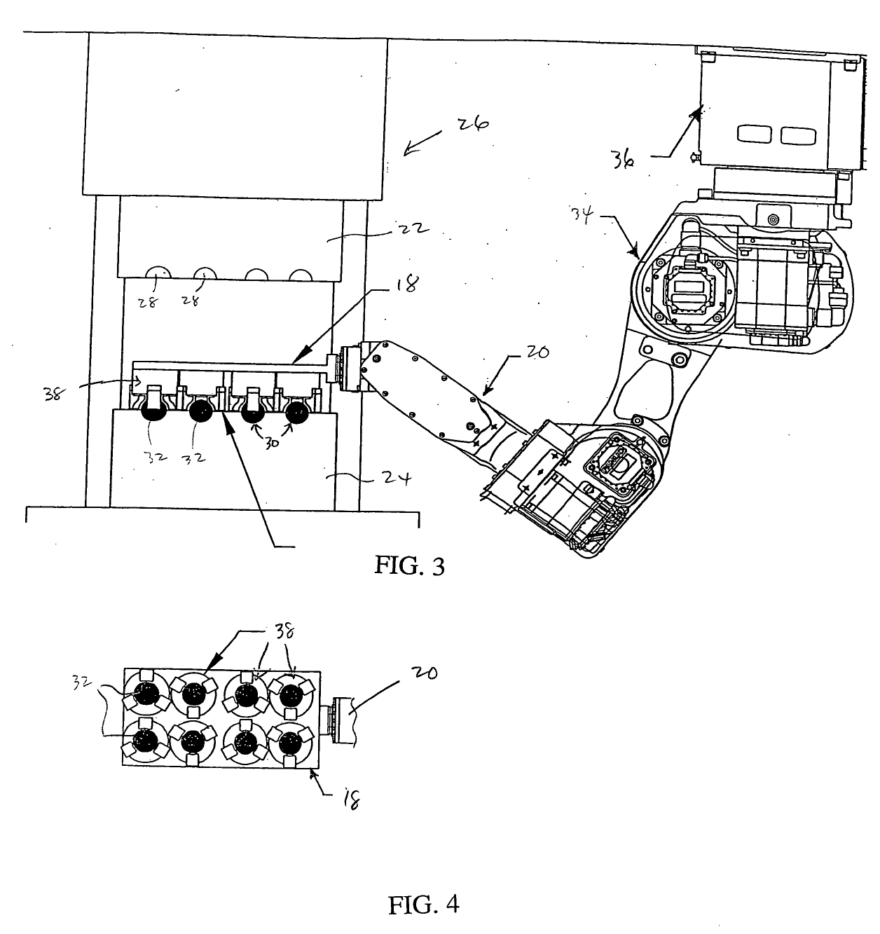

Referring now to FIG. 3, the golf ball extractor according to the invention will now be described. The extractor includes a frame 18 which is connected with a robotic arm 20 for positioning the frame between upper 22 and lower 24 mold plates of an injection molding apparatus 26. As in the prior art, the upper and lower mold plates contain opposed hemispherical cavities 28, 30 respectively, which form spherical cavities when the plates are brought together. In FIG. 3, molded golf balls 32 are shown arranged in the cavities 30 of the lower mold plate.

The robotic arm 20 is connected with a motor 34 whose operation is controlled by a controller 36. The controller controls the operation of the motor to position the frame as will be developed in greater detail below. In lieu of a robotic arm, other manipulators known in the art such as air cylinders, mechanical linkages and the like may be used to position the frame between the mold plates.

A plurality of gripping mechanisms 38 are connected with the frame. As shown in FIG. 4, one gripping mechanism is provided for each cavity in the mold plates, with the mechanisms being arranged on the frame in an array corresponding with an array of cavities in the mold plates. While eight gripping mechanisms are shown in FIG. 4, that number is only by way of example. Any number of gripping mechanisms may be provided in accordance with the number and arrangement of cavities provided in the mold plates. Moreover, as will be described below, a single gripping mechanism can be provided on a frame in accordance with the invention.

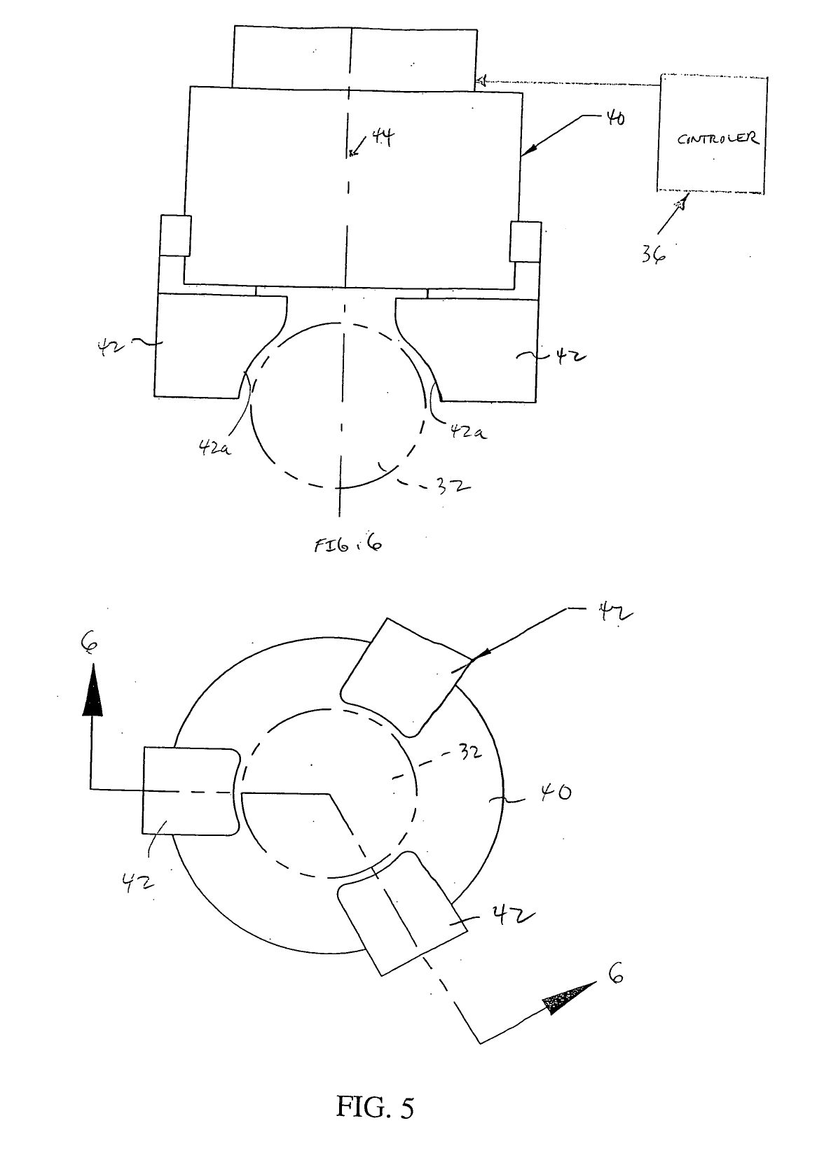

As shown more particularly in FIGS. 5 and 6, each gripping mechanism includes an internal cylinder 40 with which a plurality of gripping fingers 42 are connected. The cylinder is operable to displace the fingers relative to a central axis 44 of the gripping mechanism. This axis is aligned with an axis of the golf ball as shown in FIG. 6. The fingers 42 extend parallel to the central axis and are equally spaced about the central axis. Although three fingers are shown for each gripping mechanism, any suitable number of fingers my be provided. Operation of the cylinder is also under control of the controller 36. In lieu of a cylinder, any other suitable mechanism known to those in the art can be used to displace the gripping fingers relative to the central axis.

The gripping fingers 42 are designed to grip only the exposed portion of the molded golf ball. Thus, the fingers preferably include a contoured surface 42a which conforms to the surface contour of the golf ball 32. The fingers are made of any rigid durable material such as metal or synthetic plastic. The contoured surface of each gripping finger may be smooth or roughened or may be coated with a material which assists in gripping the golf ball surface.

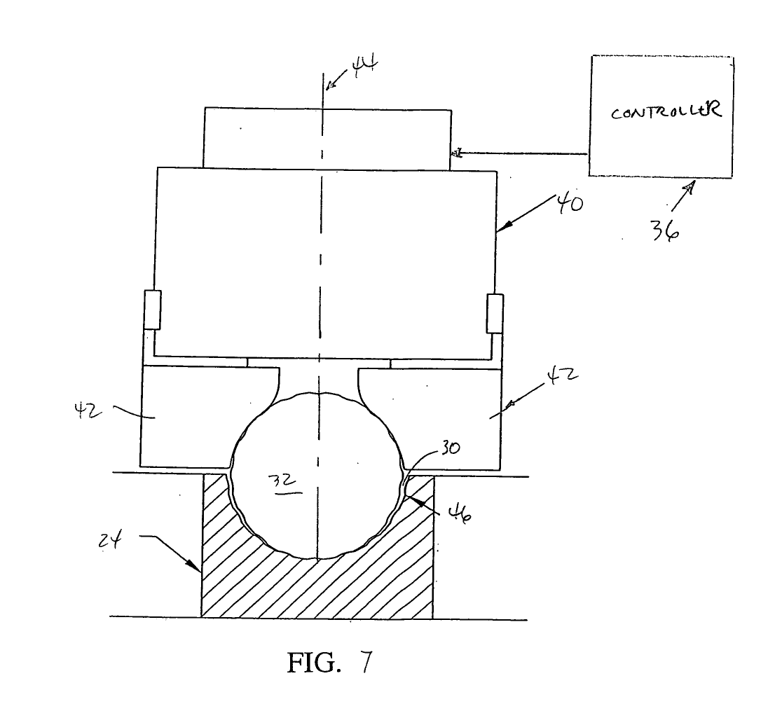

After the cover layer has been molded onto the golf balls in the golf ball mold 26, the mold plates are separated. The controller moves the multi-axis robotic arm to position the frame 18 adjacent to the molded golf balls in the mold plate cavities with the gripping mechanisms aligned with the associated golf balls. The frame is then moved to position the gripping fingers around the corresponding golf ball as shown in FIG. 6. Next, the controller operates the gripping mechanisms to simultaneously displace the gripping fingers toward the golf ball with sufficient force to partially compress the surface of the golf ball as shown in FIG. 7. By partially compressing the ball surface, it clears the projections 46 on the cavity surface used to form dimples on the golf ball surface during molding.

The controller 36 then controls the robotic arm to move the frame away from the mold 26, thereby extracting the balls from the mold cavities. The frame is then moved to a receptacle. When the gripping fingers are displaced away from the central axis, each gripping mechanism releases its golf ball which drops into the receptacle. Once released, each golf ball expands back to its normal configuration. The golf ball surface does not contain any deformations or imperfections since no ejector pins are used during the extraction process.

In most instances, when the upper and lower mold plates are separated, the golf balls are retained in the lower mold plate. However, in some instances, one or more balls may be retained in the cavities of the upper mold plate. The versatility of the invention can accommodate either situation by positioning the frame with the gripping fingers facing the plate in which one or more balls are retained and actuating the gripping fingers as described above to extract the golf balls therefrom.

In an alternate embodiment (not shown), a small hand-held frame having a single gripping mechanism connected therewith can be manually positioned between the plates for extraction of at least one golf ball. The gripping mechanism includes gripping fingers as set forth above which can be operated under pneumatic or hydraulic pressure to displace the fingers to grip the exposed surface of the ball. When the ball is compressed and freed from the cavity, the frame and gripping mechanism are withdrawn from between the mold plates and manually positioned adjacent a receptacle, and the golf ball is released for deposit therein.

While the preferred forms and embodiments of the invention have been illustrated and described, it will be apparent to those of ordinary skill in the art that various changes and modifications may be made without deviating from the inventive concepts set forth above.

What is claimed is:

1. Apparatus for removing molded golf balls from a golf ball mold, comprising:
(a) a frame;
(b) means for moving said frame relative to the golf ball mold; and
(c) at least one gripping mechanism connected with said frame, said gripping mechanism including
(1) a plurality of radially spaced gripping fingers having longitudinal axes arranged parallel to a central axis; and
(2) means for displacing said gripping fingers relative to said central axis for gripping an exposed portion of the golf ball in the golf ball mold, the golf ball having an axis aligned with said central axis, said displacing means supplying sufficient force to said gripping fingers to partially compress the golf ball so that the compressed golf ball clears protrusions in the golf ball mold when said frame is moved away therefrom, said displacing means subsequently displacing said gripping fingers away from said central axis to release the golf ball, whereby the golf ball returns to its original configuration.

2. Apparatus as defined in claim 1, wherein said gripping fingers are contoured to match the curvature of the golf ball.

3. Apparatus as defined in claim 1, wherein said gripping fingers are machined to match an aerodynamic surface contour of the golf ball.

4. Apparatus as defined in claim 2, wherein said gripping fingers are equally spaced about said central axis.

5. Apparatus as defined in claim 4, wherein three gripping fingers are provided on said gripping mechanism.

6. Apparatus as defined in claim 2, wherein said displacing means comprises a control device to move said gripping fingers between an open position spaced from said central axis and a closed position toward said central axis.

7. Apparatus as defined in claim 6, wherein a plurality of gripping mechanisms are provided which operate simultaneously for gripping a plurality of golf balls.

8. Apparatus as defined in claim 7, wherein said means for moving said frame comprises one of a robotic arm and a manipulator connected with said frame.

9. Apparatus as defined in claim 2, wherein said gripping fingers are made of a metallic material.

10. Apparatus as defined in claim 2, wherein said gripping fingers are made of a non-metallic material.

11. Apparatus as defined in claim 2, wherein said gripping fingers include a smooth gripping surface.

12. Apparatus as defined in claim 2, wherein said gripping fingers include a roughened gripping surface.

13. A method for removing molded golf balls from a golf ball mold comprising
(a) providing a frame;
(b) moving said frame relative to the golf ball mold;
(c) gripping at least one golf ball with a plurality of radially spaced gripping fingers having longitudinal axes arranged parallel to a central axis to partially compress the golf ball so that the golf ball clears protrusions in the golf ball mold;
(d) moving said frame away from said golf ball mold; and
(e) releasing the golf ball from said gripping fingers, thereby allowing the golf ball to return to its original configuration.

14. A method as defined in claim 13, and further comprising the step of aligning the said central axis of said gripping mechanism with a central axis of the golf ball.

15. A method as defined in claim 14, wherein said gripping and releasing steps are performed by displacing said gripping fingers toward and away from said central axis, respectively.
